(19) United States
(12) Patent Application Publication
(10) Pub. No.: US 2012/0209528 A1
(43) Pub. Date: Aug. 16, 2012

(54) Inversion-Based Method to Correct for the Pipe Residual Signal in Transient MWD Measurements

(75) Inventor: Gregory B. Itskovich, Houston, TX (US)

(73) Assignee: Baker Hughes Incorporated, Houston, TX (US)

(21) Appl. No.: 13/368,507

(22) Filed: Feb. 8, 2012

Related U.S. Application Data
(60) Provisional application No. 61/441,321, filed on Feb. 10, 2011.

(51) Int. Cl. G06F 19/00

(52) U.S. Cl. 702/7

(57) ABSTRACT

An apparatus and method for reducing a pipe residual signal from transient signals in an induction tool having a metallic pipe with finite, non-zero conductivity in a borehole penetrating an earth formation. The apparatus may include a transient electromagnetic (TEM) signal transmitter, at least one receiver configured to generate an output signal in response to the TEM signal, and at least one processor for estimating an updated model with an improved estimate of the resistivity property. The updated model may be estimated based on a difference between a simulated signal from an initial model and the output signal. The difference may be represented by a set of basis functions. The method includes using the apparatus.

### CROSS-REFERENCE TO RELATED APPLICATION

This application claims priority from U.S. Provisional Patent Application Ser. No. 61/441,321, filed on 10 Feb. 2011, incorporated herein by reference in its entirety.

### BACKGROUND OF THE DISCLOSURE

1. Field of the Disclosure

In one aspect, this disclosure generally relates methods and apparatuses for earth formation evaluation and, more specifically, for determining resistivity properties of the earth formation.

2. Background of the Art

Electromagnetic induction resistivity instruments can be used to determine the electrical conductivity of earth formations surrounding a wellbore. An electromagnetic induction well logging instrument may include a transmitter coil and a plurality of receiver coils positioned at axially spaced apart locations along the instrument housing. An alternating current may then be passed through the transmitter coil. Voltages which are induced in the receiver coils as a result of alternating magnetic fields induced in the earth formations are then measured. The magnitude of certain phase components of the induced receiver voltages are related to the conductivity of the media surrounding the instrument.

At the ultra-deep scale, a technology may be employed based on transient field behavior. The transient electromagnetic field method is widely used in surface geophysics. Typically, voltage or current pulses that are excited in a transmitter initiate the propagation of an electromagnetic signal in the earth formation. Electric currents diffuse outwards from the transmitter into the surrounding formation. At different times, information arrives at the measurement sensor from different investigation depths. Particularly, at a sufficiently late time, the transient electromagnetic field is sensitive predominantly to remote formation zones and only slightly depends on the resistivity distribution in the vicinity of the transmitter. This feature of transient field is especially important for logging aimed on deep depth of investigation.

In the transient measurement while drilling (MWD) measurements, the electromagnetic fields induced in the formation and in the drilling pipe are measured by two induction coils. The signals from the coils are combined in a special way to eliminate a parasitic signal from the pipe (bucking). In case of deep transient measurements, when target is placed tens of meters way from the tool, some residual signal from the pipe still presents in the late time stage of the bucked signal and can undesirably affect interpretation results if not taken into account.

There is a need for a method of reducing the pipe residual signal information acquired with real MWD tools having finite non-zero conductivity in transient field studies. The present disclosure satisfies this need.

### SUMMARY OF THE DISCLOSURE

In aspects, the present disclosure is related to an apparatus and method for electromagnetic induction well logging for determining the resistivity of earth formations penetrated by a wellbore. More specifically, the present disclosure relates to reducing a pipe residual signal from transient signals in an induction tool having a metallic pipe with finite, non-zero conductivity.

One embodiment according to the present disclosure includes a method of determining a resistivity property of an earth formation, the method comprising: producing a transient electromagnetic (TEM) signal using a transmitter on a carrier conveyed in a borehole; using at least one receiver on the carrier for producing an output signal responsive to the TEM signal, the output signal being affected by a finite, non-zero conductivity of the carrier; and using at least one processor for: (i) producing a simulated signal using an initial model, the initial model including the resistivity property, (ii) representing a difference between the simulated signal and the output signal by a set of basis functions, and (iii) using the difference for estimating an updated model, the updated model including an improved estimate of the resistivity property.

Another embodiment according to the present disclosure includes an apparatus for determining a resistivity property of an earth formation, the apparatus comprising: a carrier configured to be conveyed in a borehole; a transmitter disposed on the carrier and configured to produce a transient electromagnetic (TEM) signal; at least one receiver disposed on the carrier and configured to produce an output responsive to the TEM signal; at least one processor; and a non-transitory computer readable medium with instructions thereon that, when executed by the at least one processor: produce a simulated signal using an initial model, the initial model including the resistivity property, represent a difference between the simulated signal and the output signal by a set of basis functions, and use the difference for estimating an updated model, the updated model including an improved estimate of the resistivity.

Another embodiment according to the present disclosure includes a non-transitory computer-readable medium product having instructions thereon that, when executed, cause the at least one processor to perform a method, the method comprising: producing a simulated signal using an initial model, the initial model including a resistivity property; representing a difference between the simulated signal and an output signal by a set of basis functions, wherein the output signal is produced using at least one receiver on a carrier responsive to a transient electromagnetic (TEM) signal produced using a transmitter on the carrier conveyed in a borehole and wherein the output signal is affected by a finite, non-zero conductivity of the carrier; and using the difference for estimating an updated model, the updated model including an improved estimate of the resistivity property.

Examples of the more important features of the disclosure have been summarized rather broadly in order that the detailed description thereof that follows may be better understood and in order that the contributions they represent to the art may be appreciated. There are, of course, additional features of the disclosure that will be described hereinafter and which will form the subject of the claims appended hereto.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1 shows a schematic of a drilling rig with an electric induction tool according to one embodiment of the present disclosure;

FIG. 2 shows a schematic of an electric induction tool according to one embodiment of the present disclosure;

FIG. 3 shows a chart of signal with and without pipe in a 1 ohmm homogeneous formation;

FIG. 4 shows a chart of signal with and without pipe in a 10 ohmm homogeneous formation;

FIG. 5 shows a chart of signal with and without pipe in a 100 ohmm homogeneous formation;

FIG. 6 shows a chart of with a residual signal approximation in a 1 ohmm homogenous formation according to one embodiment of the present disclosure;

FIG. 7 shows a chart of with a residual signal approximation in a 10 ohmm homogenous formation according to one embodiment of the present disclosure;

FIG. 8 shows a chart of with a residual signal approximation in a 100 ohmm homogenous formation according to one embodiment of the present disclosure;

FIG. 9 shows a chart of with a residual signal approximation formation with an ahead-place boundary between 50 ohmm and 1 ohmm layers according to one embodiment of the present disclosure; and

FIG. 10 shows a flow chart of a method of reducing an error due to a residual signal according to one embodiment of the present disclosure.

### DETAILED DESCRIPTION OF THE DISCLOSURE

The present disclosure relates to apparatuses and methods for electromagnetic induction well logging for determining the resistivity of earth formations penetrated by a wellbore. More specifically, the present disclosure relates to reducing a pipe residual signal from transient signals in an induction tool having a metallic pipe with finite, non-zero conductivity. The present disclosure is susceptible to embodiments of different forms. There are shown in the drawings, and herein will be described in detail, specific embodiments of the present disclosure with the understanding that the present disclosure is to be considered an exemplification of the principles of the present disclosure and is not intended to limit the present disclosure to that illustrated and described herein.

In the present disclosure, a resistivity property may include, but is not limited to, one of: a resistivity of the formation and a distance to a bed boundary in the formation. Herein, the term “information” may relate to one or more of: (i) raw data), (ii) processed data, and (iii) signals.

In one aspect, the present disclosure relates to reducing an error in an estimation of formation parameters due to residual signals from a conductive bottom hole assembly (BHA). One benefit of the proposed technique may be more significant when a target is located tens of meters away from the tool.

The residual signal from a conductive drill may be quantified and corrected via an algorithm employing linear inversion. The error reduction algorithm may use prior knowledge about the “initial guess” (formation model). The initial guess may be obtained through a non-linear inversion in instances where measured information might be affected by the residual effect due to conductive pipe. Then, the resulting model may be used as an initial guess for the linear inversion to reduce an error due to the residual error contribution due to the conductive pipe. Additionally, the linear inversion may be repeated to obtain a next approximation if a higher degree of error compensation is desired. Another advantage of the algorithm using linear inversion may be that the algorithm may also be used to reduce errors due to system imperfections due to, but not limited to, tool bedding and systematic noise of electronics.

The residual signal may be filtered out using an inversion. If m unknown parameters of formation model to be denoted by Mₖ, then n experimental observations will be Oⱼ. These information sets may be arranged as column matrices M and O:

M^{T}=(M₁,M₂, . . . Mₘ), (1)

O^{T}=(O₁,O₂, . . . Oₙ). (2)

where T indicates a transpose. It may be assumed that a known functional relationship, A (forward modeling), exists between the models of parameters and the observations:

Oⱼ=Aⱼ(M₁,M₂, . . . Mₘ) j=1,2, . . . n (3)

An initial guess Mₖ^{a} may be required for the model parameters:

M^{Ta}=(M₁^{a},M₂^{a} . . . Mₘ^{a}) (4)

If function Aⱼ varies smoothly, then a Taylor series expansion may be made about the initial guess:

$${O}_{j} = {A}_{j} ( {M}_{1}^{a} , {M}_{2}^{a} … {M}_{m}^{a} ) + {\sum }_{k = 1}^{m} {[ \frac{\partial {A}_{j}}{\partial {M}_{k}} ]}_{{M}_{K}^{A}} ( {M}_{k} - {M}_{k}^{a} ) + … \qquad ( 5 )$$

where the higher order terms indicated at the end of eqn. 5 may be neglected in order to linearize the problem.

If the difference between observations and model computations, which are to be minimized, is expressed as y:

yⱼ=Oⱼ−Aⱼ(M₁^{a},M₂^{a} . . . Mₘ^{a}) j=1,2, . . . n (6)

then the difference in the initial approximation and the next approximation to the model parameters will be x.

xₖ=Mₖ−Mₖ^{a}, k=1,2, . . . m (7)

The first partial derivatives defined for the initial estimations Mₖ^{a} may be represented as matrix Â of Jacobians with a size of [m×n] with elements Aⱼₖ:

$$\begin{matrix}\hat{A} = [ \begin{matrix}\frac{\partial {A}_{1}}{\partial {M}_{1}} & \frac{\partial {A}_{1}}{\partial {M}_{2 }} & … & \frac{\partial {A}_{1}}{\partial {M}_{m}} \\ \frac{\partial {A}_{2}}{\partial {M}_{1}} & \frac{\partial {A}_{2}}{\partial {M}_{2}} & … & \frac{\partial {A}_{2}}{\partial {M}_{m}} \\ ⋮ & & & \\ ⋮ & & & \\ \frac{\partial {A}_{n}}{\partial {M}_{1}} & \frac{\partial {A}_{n}}{\partial {M}_{2}} & … & \frac{\partial {A}_{n}}{\partial {M}_{m}}\end{matrix} ] & ( 8 ) \\ {A}_{jk} = \frac{\partial {A}_{j}}{\partial {M}_{k}} & ( 9 )\end{matrix}$$

Eqns. 6-8 may be combined and expressed as:

\vec{y}=Â\vec{x} (10)

and the solution to the eqn. 10 is:

\vec{x}=Â⁻¹\vec{y} (11)

If initial guess is not good enough, i.e., the difference in a least squares sense between the observations O and y exceeds a specified threshold value, then the next approximation may be obtained as:

Mₖ^{b}=xₖ+Mₖ^{a}, k=1,2 . . . m. (12)

In some circumstances, functional relationship, A, between the models of parameters and the observations may not be exactly known. Under these circumstances, A may be defined using:

Oⱼ−Pⱼ=Aⱼ(M₁,M₂, . . . Mₘ) j=1,2 . . . n, (13)

where Pⱼ is a vector that can be presented as a linear combination of some basis functions ƒ(t)=1/t^{i-1/2}, i=1, 2, . . . p and some number p of unknown coefficients Mₘ₊₁, Mₘ₊₂, . . . Mₘ₊ₚ:

$$P ( {t}_{j} ) = {\sum }_{i = 1}^{i = p} \frac{{M}_{m + i}}{{t}_{j}^{i - 1 / 2}} , i = 1 , 2 , … p \qquad ( 14 )$$

The approximation in eqn. 14 follows from analysis of the solution for the signal measured at the late stage in the receiver when both transmitter and receiver coils are placed on the pipe and surrounding formation is homogeneous.

Eqn. 10 may be modified to use A of eqn. 14 to create an expression for the circumstances expressed with eqn. 13. Thus, we have:

\vec{y}=Âₚ\vec{x}ₚ, (15)

where modified matrix Âₚ may be represented as:

$$\hat{A} = [ \begin{matrix}\frac{\partial {A}_{1}}{\partial {M}_{1}} & \frac{\partial {A}_{1}}{\partial {M}_{2}} & … & \frac{\partial {A}_{1}}{\partial {M}_{m}} , & 0 & 0 & … & 0 \\ \frac{\partial {A}_{2}}{\partial {M}_{1}} & \frac{\partial {A}_{2}}{\partial {M}_{2}} & … & \frac{\partial {A}_{2}}{\partial {M}_{m}} , & 0 & 0 & … & 0 \\ ⋮ & & & & & & & \\ \frac{\partial {A}_{n - l }}{\partial {M}_{1 }} & \frac{\partial {A}_{n - 1}}{\partial {M}_{2 }} & … & \frac{\partial {A}_{n - l}}{\partial {M}_{m}} , & \frac{1}{{t}_{n - l}^{1 / 2}} & \frac{1}{{t}_{n - l}^{3 / 2}} & … & \frac{1}{{t}_{n - l}^{p - 1 / 2}} \\ ⋮ & & & & & & & \\ ⋮ & & & & & & & \\ \frac{\partial {A}_{n}}{\partial {M}_{1}} & \frac{\partial {A}_{n}}{\partial {M}_{2}} & … & \frac{\partial {A}_{n}}{\partial {M}_{m}} , & \frac{1}{{t}_{n}^{1 / 2}} & \frac{1}{{t}_{n}^{3 / 2}} & … & \frac{1}{{t}_{n}^{p - 1 / 2}}\end{matrix} ] , \qquad ( 16 )$$

where modified vector \vec{x}ₚ may be defined as:

\vec{x}ₚ= x̅+\vec{x}ₜ, (17)

\vec{x}=((M₁−M₁^{a}),(M₂−M₂^{a}), . . . (Mₘ−Mₘ^{a})) (18)

\vec{x}ₜ=(Mₘ₊₁,Mₘ₊₂, . . . Mₘ₊ₚ). (19)

By solving eqn. 15, both corrections for parameters of formation \vec{x}ₖ=Mₖ−Mₖ^{a} and coefficients \vec{x}ₜ=(Mₘ₊₁, Mₘ₊₂, . . . Mₘ₊ₚ) may be obtained.

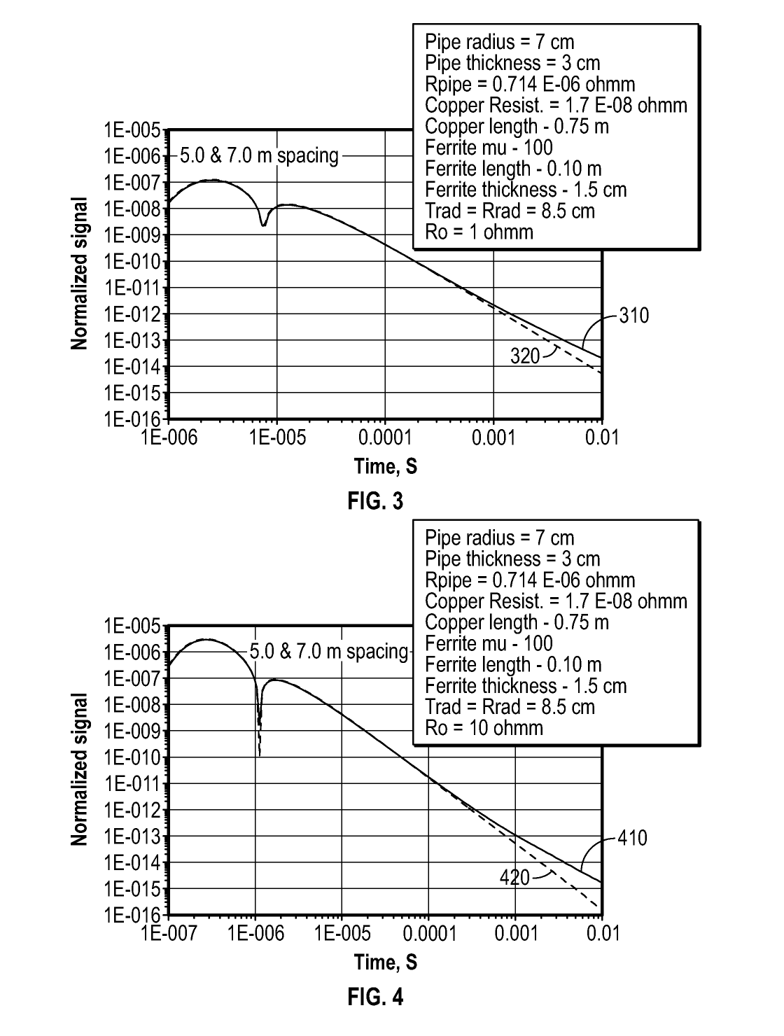

The residual signals, \vec{y}, may be estimated by taking a difference between the two signals presented in FIGS. 3-5 (discussed below) and then, solving a least square problem with respect to the coefficients

Mᵢ, i=1, . . . p

\vec{y}=\hat{T}\vec{x}ₜ,

where \vec{x}=(M₁, M₂, . . . Mₚ) and matrix \hat{T} is comprised of odd half powers of time:

$$\hat{T} = [ \begin{matrix}\frac{1}{{t}_{n - l}^{1 / 2}} & \frac{1}{{t}_{n - l}^{3 / 2}} & … & \frac{1}{{t}_{n - l}^{p - 1 / 2}} \\ \frac{1}{{t}_{n - l + 1}^{1 / 2}} & \frac{1}{{t}_{n - l + 1}^{3 / 2}} & … & \frac{1}{{t}_{n - l + 1}^{p - 1 / 2}} \\ ⋮ & & & \\ ⋮ & & & \\ \frac{1}{{t}_{n}^{1 / 2}} & \frac{1}{{t}_{n}^{3 / 2}} & … & \frac{1}{{t}_{n}^{p - 1 / 2}}\end{matrix} ]$$

The time interval may be from t=tₙ₋ₗ to t=tₜ and l is the number of discrete time points where signal is performed.

In general, a time moment, tₙ₋ₗ, may be unknown and may be a subject for inversion as well. This means that eqn. 15 may be solved for multiple instances each with a different value of tₙ₋ₗ, and the instance which provides the smallest misfit is the solution. Depending on the formation resistivity, the typical values of tₙ₋ₗ may be in the interval from 0.5e-04 to 3e-04 seconds. Most cases may be solved while selecting tₙ₋ₗ around 1e-04 seconds. Typically, all linear inversions are performed with the same initial guess and performing a linear inversion will consume significantly less time compared to performing a nonlinear inversion. For nonlinear inversions, providing the initial guess may be performed at the first step when the residual signal from the pipe may be present in the data as a systematic noise.

Since this inversion-based approach to reducing errors in formation parameters does not rely on any specific cause for the existence of the uncompensated signal, the error reduction may also be used to compensate for imperfections in transient signals caused by the tool bedding, systematic noise of electronics, etc.

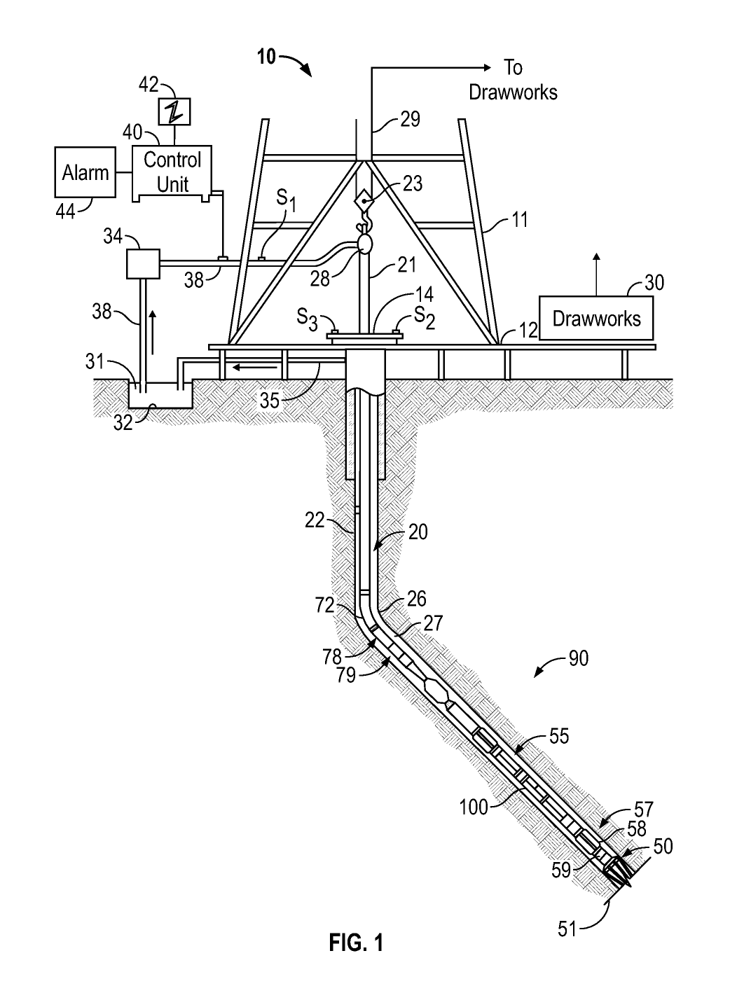

FIG. 1 shows a schematic diagram of a drilling system 10 with a carrier 20 carrying a drilling assembly 90 (also referred to as the bottom hole assembly, or “BHA”) conveyed in a “wellbore” or “borehole” 26 for drilling the wellbore. The term “carrier” as used herein means any device, device component, combination of devices, media and/or member that may be used to convey, house, support, or otherwise facilitate the use of another device, device component, combination of devices, media and/or member. Exemplary non-limiting carriers include drill strings of the coiled tube type, of the jointed pipe type, and any combination or portion thereof. Other carrier examples include casing pipes, wirelines, wireline sondes, slickline sondes, drop shots, downhole subs, BHAs, drill string inserts, modules, internal housings, and substrate portions thereof. The BHA 90 may include a tool 100 configured for performing electric induction measurements. The drilling system 10 includes a conventional derrick 11 erected on a floor 12 which supports a rotary table 14 that is rotated by a prime mover such as an electric motor (not shown) at a desired rotational speed. The carrier (shown here as a drillstring) 20 includes a tubing such as a drill pipe 22 or a coiled-tubing extending downward from the surface into the borehole 26. The drillstring 20 is pushed into the wellbore 26 when a drill pipe 22 is used as the tubing. For coiled-tubing applications, a tubing injector, such as an injector (not shown), however, is used to move the tubing from a source thereof, such as a reel (not shown), to the wellbore 26. The drill bit 50 attached to the end of the drillstring breaks up the geological formations when it is rotated to drill the borehole 26. If a drill pipe 22 is used, the drillstring 20 is coupled to a drawworks 30 via a Kelly joint 21, swivel 28, and line 29 through a pulley 23. During drilling operations, the drawworks 30 is operated to control the weight on bit, which is an important parameter that affects the rate of penetration. The operation of the drawworks is well known in the art and is thus not described in detail herein.

During drilling operations, a suitable drilling fluid 31 from a mud pit (source) 32 is circulated under pressure through a channel in the drillstring 20 by a mud pump 34. The drilling fluid passes from the mud pump 34 into the drillstring 20 via a desurger (not shown), fluid line 38 and Kelly joint 21. The drilling fluid 31 is discharged at the borehole bottom 51 through an opening in the drill bit 50. The drilling fluid 31 circulates uphole through the annular space 27 between the drillstring 20 and the borehole 26 and returns to the mud pit 32 via a return line 35. The drilling fluid acts to lubricate the drill bit 50 and to carry borehole cutting or chips away from the drill bit 50. A sensor S₁ preferably placed in the line 38 provides information about the fluid flow rate. A surface torque sensor S₂ and a sensor S₃ associated with the drillstring 20 respectively provide information about the torque and rotational speed of the drillstring. Additionally, a sensor (not shown) associated with line 29 is used to provide the hook load of the drillstring 20.

In one embodiment of the disclosure, the drill bit 50 is rotated by only rotating the drill pipe 22. In another embodiment of the disclosure, a downhole motor 55 (mud motor) is disposed in the drilling assembly 90 to rotate the drill bit 50 and the drill pipe 22 is rotated usually to supplement the rotational power, if required, and to effect changes in the drilling direction.

In the preferred embodiment of FIG. 1, the mud motor 55 is coupled to the drill bit 50 via a drive shaft (not shown) disposed in a bearing assembly 57. The mud motor 55 rotates the drill bit 50 when the drilling fluid 31 passes through the mud motor 55 under pressure. The bearing assembly 57 supports the radial and axial forces of the drill bit 50. A stabilizer 58 coupled to the bearing assembly 57 acts as a centralizer for the lowermost portion of the mud motor assembly.

In one embodiment of the disclosure, a drilling sensor module 59 is placed near the drill bit 50. The drilling sensor module contains sensors, circuitry and processing software and algorithms relating to the dynamic drilling parameters. Such parameters preferably include bit bounce, stick-slip of the drilling assembly, backward rotation, torque, shocks, borehole and annulus pressure, acceleration measurements and other measurements of the drill bit condition. A suitable telemetry or communication sub 72 using, for example, two-way telemetry, is also provided as illustrated in the drilling assembly 90. The drilling sensor module processes the sensor information and transmits it to the surface control unit 40 via the telemetry system 72.

The communication sub 72, a power unit 78 and an MWD tool 79 are all connected in tandem with the drillstring 20. Flex subs, for example, are used in connecting the MWD tool 79 in the drilling assembly 90. Such subs and tools form the bottom hole drilling assembly 90 between the drillstring 20 and the drill bit 50. The drilling assembly 90 makes various measurements including the pulsed nuclear magnetic resonance measurements while the borehole 26 is being drilled. The communication sub 72 obtains the signals and measurements and transfers the signals, using two-way telemetry, for example, to be processed on the surface. Alternatively, the signals can be processed using a downhole processor in the drilling assembly 90.

The surface control unit or processor 40 also receives signals from other downhole sensors and devices and signals from sensors S₁-S₃ and other sensors used in the system 10 and processes such signals according to programmed instructions provided to the surface control unit 40. The surface control unit 40 displays desired drilling parameters and other information on a display/monitor 42 utilized by an operator to control the drilling operations. The surface control unit 40 preferably includes a computer or a microprocessor-based processing system, memory for storing programs or models and information, a recorder for recording information, and other peripherals. The control unit 40 is preferably adapted to activate alarms 44 when certain unsafe or undesirable operating conditions occur.

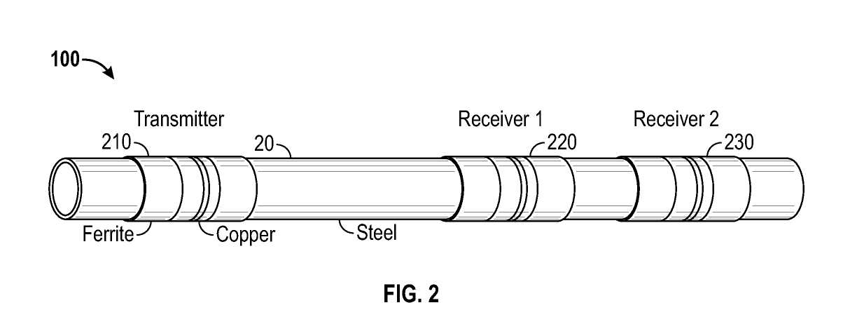

FIG. 2 shows a schematic of tool 100. The tool 100 may include a transmitter 210 and at least two receiver coils 220, 230 disposed along drillstring 20. The transmitter 210 may be configured to impart a transient electromagnetic signal into an earth formation. The at least two receiver coils 220, 230 may be configured to receive a transient electromagnetic signal from the earth formation and convert the received signal into an output signal. Tool 100 may have the following non-limiting exemplary parameters:

Pipe radius=7 cm

Pipe thickness=3 cm

Resistivity of drill=0.714 E-06 ohmm

Resistivity of copper=1.7 E-08 ohmm

Copper length—0.75 m

Ferrite magnetic permeability=100

Ferrite length—0.10 m

Ferrite thickness—1.5 cm

Transmitter/Receiver coils radius=8.5 cm, Transmitter current=1 A

First receiver spacing is 5 m from the transmitter

Second receiver spacing is 7 m from the transmitter

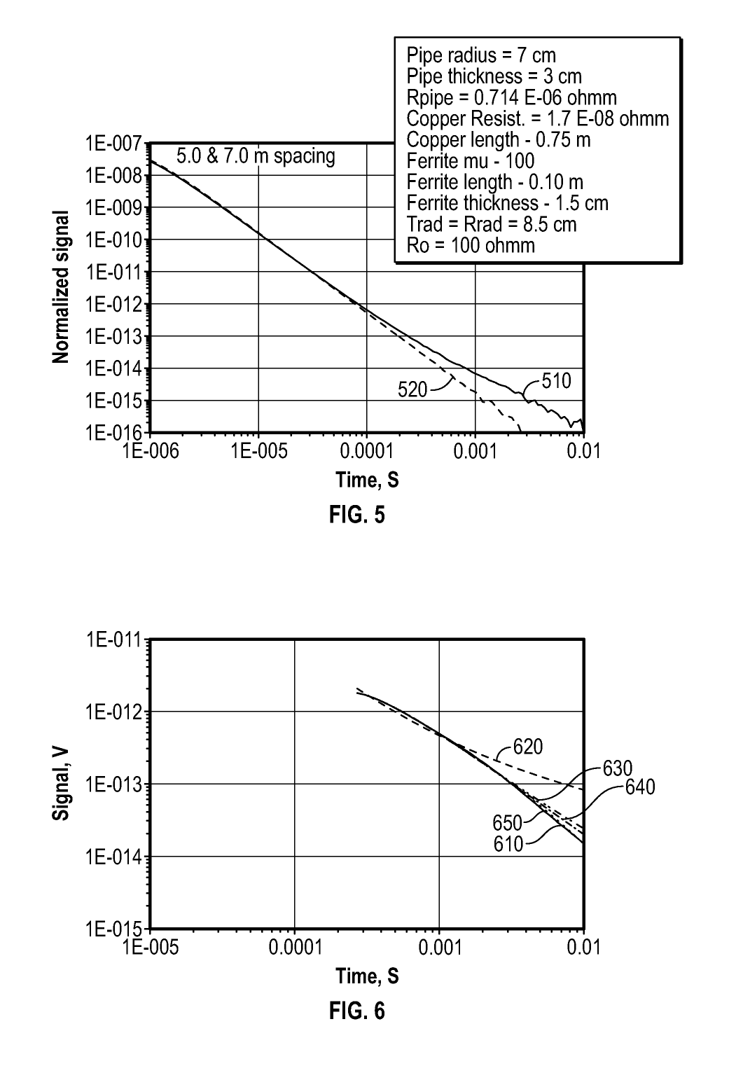

FIGS. 3-5 show a chart of curves representing modeling results where an output signal (a bucked signal) in the presence of homogeneous formation is compared with a one dimensional signal from the earth formation in the absence of conductive pipe. The bucked signal may be obtained by combining the signals from the two receivers using known methods. In one embodiment of the disclosure, a weighted combination of the two signals may be used. In FIG. 3, curve 310 is a modeled signal with conductive pipe, and curve 320 is a modeled signal without conductive pipe. The undercompensated pipe has an effect on the signal which may be observed to begin at about 2 milliseconds in a homogeneous formation with a resistivity of 1 ohmm. Similarly, in FIG. 4, curve 410 is a modeled signal with conductive pipe, and curve 420 is a modeled signal without conductive pipe. In a homogeneous formation with a resistivity of about 10 ohmm, the undercompensated pipe has an effect on the signal that may be observed beginning at 0.1 milliseconds. In FIG. 5, curve 510 is a modeled signal with conductive pipe, and curve 520 is a modeled signal without conductive pipe. In a homogeneous formation with a resistivity of about 100 ohmm, the undercompensated pipe has an effect on the signal that may be observed beginning at 0.05 milliseconds. The uncompensated residual signal may represent a systematic noise that affects interpretation results if not taken into account.

FIG. 6 shows a chart of curves representing estimates of residual signals when the number of terms, p, in the series of eqn. 14 varies from 2 to 5 according to one embodiment of the present disclosure. Curve 610 represents the residual signal in a 1 ohmm formation. Curve 620 represents an estimated residual signal using 2 terms. Curve 630 represents an estimated residual signal using 3 terms. Curve 640 represents an estimated residual signal using 4 terms. Curve 650 represents an estimated residual signal using 5 terms. It may be observed that curve 640 may provide a satisfactory fit with curve 610 below 3 milliseconds.

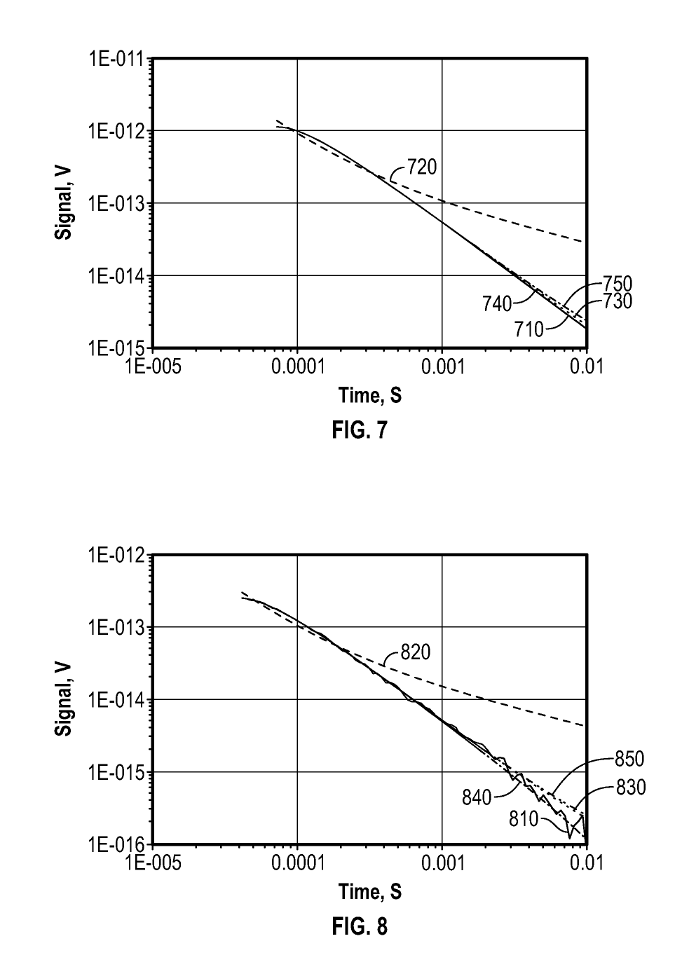

FIG. 7 shows a chart of curves representing estimates of residual signals when the number of terms, p, in the series of eqn. 14 varies from 2 to 5 according to one embodiment of the present disclosure. Curve 710 represents the residual signal in a 10 ohmm formation. Curve 720 represents an estimated residual signal using 2 terms. Curve 730 represents an estimated residual signal using 3 terms. Curve 740 represents an estimated residual signal using 4 terms. Curve 750 represents an estimated residual signal using 5 terms. It may be observed that curve 740 may provide a satisfactory fit with curve 710 below 3 milliseconds.

FIG. 8 shows a chart of curves representing estimates of residual signals when the number of terms, p, in the series of eqn. 14 varies from 2 to 5 according to one embodiment of the present disclosure. Curve 810 represents the residual signal in a 1 ohmm formation. Curve 820 represents an estimated residual signal using 2 terms. Curve 830 represents an estimated residual signal using 3 terms. Curve 840 represents an estimated residual signal using 4 terms. Curve 850 represents an estimated residual signal using 5 terms. It may be observed that curve 840 may provide a satisfactory fit with curve 810 below 3 milliseconds.

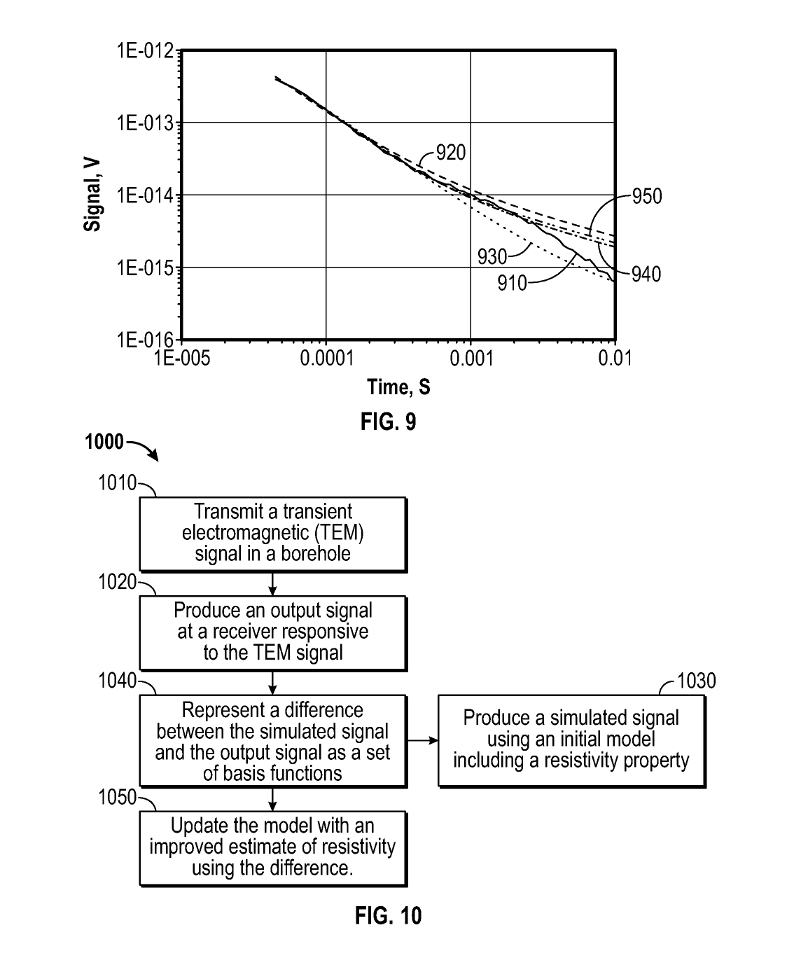

FIG. 9 shows a chart of curves representing estimates of residual signals when the number of terms, p, in the series of eqn. 14 varies from 2 to 5 according to one embodiment of the present disclosure. Curve 910 represents the residual signal when the tool 100 is placed in a resistive 50 ohmm layer and a 1 ohmm conductive layer is placed 30 meters ahead of the tool 100. Curve 920 represents an estimated residual signal using 2 terms. Curve 930 represents an estimated residual signal using 3 terms. Curve 940 represents an estimated residual signal using 4 terms. Curve 950 represents an estimated residual signal using 5 terms. Again, it may be observed that curve 940 may provide a satisfactory fit with curve 910 below 3 milliseconds.

FIG. 10 shows of flow chart of a method 1000 according to one embodiment of the present disclosure. In step 1010, a TEM signal may be transmitted into an earth formation by transmitter 210 in a borehole 26. In step 1020, at least one receiver 220, 230 may produce an output signal in response to a received TEM signal. In step 1030, a simulated signal (initial guess) may be produced using an initial model that includes a resistivity property. The initial model may use a nonlinear inversion. In step 1040, the difference between the output signal of step 1020 and the simulated signal of step 1030 may be represented as a set of basis functions. In step 1050, the model may be updated with an improved estimate for the resistivity property using the difference represented by the basis functions. In some embodiments, step 1030 may be performed before step 1020 or before step 1010.

While the disclosure has been described with reference to exemplary embodiments, it will be understood that various changes may be made and equivalents may be substituted for elements thereof without departing from the scope of the disclosure. In addition, many modifications will be appreciated to adapt a particular instrument, situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

While the foregoing disclosure is directed to the one mode embodiments of the disclosure, various modifications will be apparent to those skilled in the art. It is intended that all variations within the scope of the appended claims be embraced by the foregoing disclosure.

We claim:

1. A method of determining a resistivity property of an earth formation, the method comprising:
producing a transient electromagnetic (TEM) signal using a transmitter on a carrier conveyed in a borehole;
using at least one receiver on the carrier for producing an output signal responsive to the TEM signal, the output signal being affected by a finite, non-zero conductivity of the carrier; and
using at least one processor for:
(i) producing a simulated signal using an initial model, the initial model including the resistivity property,
(ii) representing a difference between the simulated signal and the output signal by a set of basis functions, and
(iii) using the difference for estimating an updated model, the updated model including an improved estimate of the resistivity property.

2. The method of claim 1 wherein the set of basis functions comprises t^{-n/2} where t is a time and n is an integer.

3. The method of claim 1 further comprising using, for the at least one receiver, a first receiver and a second receiver.

4. The method of claim 1 further comprising:
estimating the initial model by an inversion of the output signal.

5. The method of claim 1, further comprising:
estimating the updated model by an inversion of the difference between the simulated signal and the output signal.

6. The method of claim 5, wherein the inversion is selected from: (i) a one-dimensional inversion, or (ii) a two-dimensional inversion.

7. An apparatus for determining a resistivity property of an earth formation, the apparatus comprising:
a carrier configured to be conveyed in a borehole;
a transmitter disposed on the carrier and configured to produce a transient electromagnetic (TEM) signal;
at least one receiver disposed on the carrier and configured to produce an output responsive to the TEM signal;
at least one processor; and
a non-transitory computer readable medium with instructions thereon that, when executed by the at least one processor:
produce a simulated signal using an initial model, the initial model including the resistivity property,
represent a difference between the simulated signal and the output signal by a set of basis functions, and
use the difference for estimating an updated model, the updated model including an improved estimate of the resistivity.

8. The apparatus of claim 7 wherein the set of basis functions comprises t^{-n/2} where t is a time and n is an integer.

9. The apparatus of claim 7 further comprising using, for the at least one receiver, a first receiver and a second receiver.

10. The apparatus of claim 7, wherein the non-transitory computer-readable medium further comprises instructions that, when executed, cause the at least one processor to:
estimate the initial model by an inversion of the output signal.

11. The apparatus of claim 7, wherein the non-transitory computer-readable medium further comprises instructions that, when executed, cause the at least one processor to:
estimate the updated model by an inversion of the difference between the simulated signal and the output signal.

12. The apparatus of claim 11, wherein the inversion is in at least one dimension.

13. A non-transitory computer-readable medium product having instructions thereon that, when executed, cause the at least one processor to perform a method, the method comprising:
producing a simulated signal using an initial model, the initial model including a resistivity property;
representing a difference between the simulated signal and an output signal by a set of basis functions, wherein the output signal is produced using at least one receiver on a carrier responsive to a transient electromagnetic (TEM) signal produced using a transmitter on the carrier conveyed in a borehole and wherein the output signal is affected by a finite, non-zero conductivity of the carrier; and
using the difference for estimating an updated model, the updated model including an improved estimate of the resistivity property.

14. The non-transitory computer-readable medium product of claim 13 further comprising at least one of: (i) a ROM, (ii) an EPROM, (iii) an EEPROM, (iv) a flash memory, or (v) an optical disk.
